(19) United States
(12) Patent Application Publication
(10) Pub. No.: US 2014/0325934 A1
(43) Pub. Date: Nov. 6, 2014

(54) SCUFFGUARD FOR A STAIR RISER

(71) Applicants: Naomi Eversley, Charlotte, NC (US); Ronald Eversley, Charlotte, NC (US)

(72) Inventors: Naomi Eversley, Charlotte, NC (US); Ronald Eversley, Charlotte, NC (US)

(21) Appl. No.: 13/875,883

(22) Filed: May 2, 2013

(51) Int. Cl. E04B 1/92; C09J 7/04; C09J 7/02

(52) U.S. Cl. CPC E04B 1/92; C09J 7/026; C09J 7/04
USPC 52/741.3; 428/343; 442/151; 428/337; 428/220; 428/195.1; 428/198; 428/40.1; 428/354

(57) ABSTRACT

A scuffguard for a stair riser includes a first layer, a second layer, and a third layer. The first layer has a front side, a back side, and a thickness. The front side of the first layer has a front face being made from a scuff resistant material. The second layer is a pressure sensitive adhesive on the back side of the first layer. The pressure sensitive adhesive is for attaching the first layer to a stair riser. The third layer is removably attached to the pressure sensitive adhesive. Whereby, the third layer may be removed from the pressure sensitive adhesive to expose the pressure sensitive adhesive for installation of the first layer on the stair riser. The method of protecting a stair riser uses the scuffguard, where the third layer is removed from the pressure sensitive adhesive, and the first layer is attached to the stair riser via the pressure sensitive adhesive.

### FIELD OF THE INVENTION

The present invention relates generally to stairs and a device and method for protecting stairs. Namely, the present invention relates to a device for protecting a stair riser and a method of protecting a stair riser using such a device.

### BACKGROUND OF THE INVENTION

A set of stairs, stairway, staircase, stairwell, flight of stairs, or simply stairs is a common structure designed to bridge a large vertical distance by dividing it into smaller vertical distances, called steps. Stair structures may be built in many different shapes and sizes, including but not limited to, straight, round, spiral, angled, etc. The step of a set of stairs is composed of the tread and riser. The tread is the horizontal part of the stairway that is stepped on. The riser is the vertical portion between each tread on the stair. Stairs can be made from many different flooring materials including, but not limited to, hardwood, carpet, tile, stone, etc.

With hardwood stairs, typically the tread is made of stained hardwood and the riser is a painted board. Typically the riser is painted the same color as the trim of the house, like a light colored white or off white. One problem discovered by the instant invention is that owners of hardwood floor stairs encounter constant scuffing of the stair riser. Scuffing, as used herein, may refer to any marks, stains, discolorations, dirt, etc. on the face of the stair riser. Because the stair riser is typically painted such a light color, like a white or off white, the scuffing of the stair riser may be very noticeable and undesirable for owners. In addition, because stairs are constantly used to move from one floor of a structure like a house to another floor, stair risers are very susceptible to scuffing.

The current known solutions to scuffed stair risers are to clean or repaint the scuff marks. This can be a constant choir as stairs are used so frequently and risers are so susceptible to scuffing. In addition, because of the uneven and vertical nature of stairs, cleaning and repainting can be very difficult and dangerous. As such, there is clearly a need to provide a product, device, apparatus or method, that helps prevent or eliminate scuffing of stair risers and/or helps remove or clean any scuff marks.

The instant invention is designed to address the above mentioned problems by providing a scuffguard for a stair riser.

### SUMMARY OF THE INVENTION

The instant invention is directed towards a scuffguard for a stair riser and a method of protecting a stair riser using such a scuffguard. The scuffguard for a stair riser includes a first layer, a second layer, and a third layer. The first layer has a front side, a back side, and a thickness. The front side of the first layer has a front face being made from a scuff resistant material. The second layer is a pressure sensitive adhesive on the back side of the first layer. The pressure sensitive adhesive is for attaching the first layer to a stair riser. The third layer is removably attached to the pressure sensitive adhesive. Whereby, the third layer may be removed from the pressure sensitive adhesive to expose the pressure sensitive adhesive for installation of the first layer on the stair riser.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is an environmental prospective view of a plurality of scuffguards for a stair riser according to one embodiment of the instant invention installed on a set of stairs.

FIG. 2 is an environmental prospective view of the plurality of scuffguards for a stair riser from FIG. 1 being partially broken away from the set of stairs.

FIG. 3 is a prospective view showing the steps for installing a scuffguard according to one embodiment of the instant invention on the bottom riser of a set of stairs.

FIG. 4 is a prospective view showing the steps for installing a scuffguard according to another embodiment of the instant invention on the bottom riser of a set of stairs.

FIGS. 5A-5B are front views of the scuffguard for a stair riser according to various embodiments of the instant invention.

FIGS. 6A-6C are back views of the scuffguard for a stair riser according to various embodiments of the instant invention.

FIG. 6 is a back view of the scuffguard for a stair riser according to one embodiment of the instant invention.

FIG. 7 is a front view of multiple scuffguard for a stair riser connected together according to another embodiment of the instant invention.

### DETAILED DESCRIPTION OF THE INVENTION

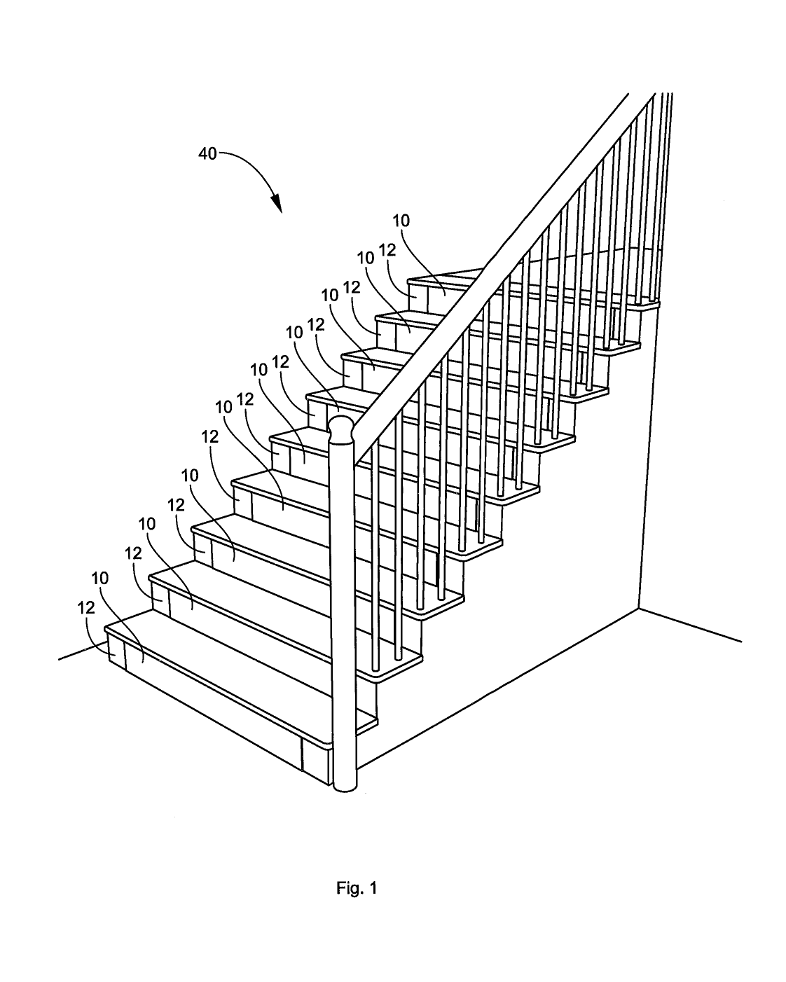

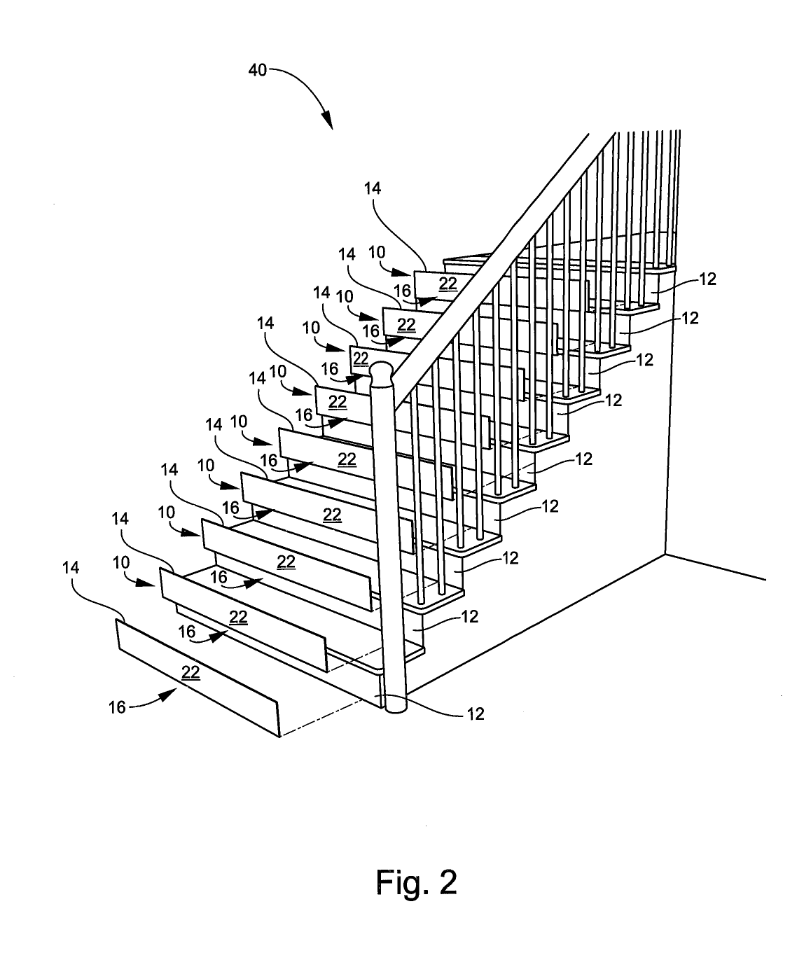

Referring to the drawings, wherein like numerals indicate like elements, there is shown in FIGS. 1-2 an embodiment of a scuffguard 10 for a stair riser 12. The instant invention is directed toward scuffguard 10 for protecting a stair riser 12 or a plurality of scuffguards 10 for protecting a plurality of stair risers 12 in a set of stairs 40. The scuffguard 10 may be provided on one stair riser 12 of a set of stairs 40, on multiple stair risers 12 in set of stairs 40, or on all stair risers 12 of set of stairs 40. Scuffguard 10 may protect the stair riser 12 by reducing or preventing all together any scuff marks, stains, discolorations, dirt, etc. on the face of the stair riser 12. Scuffguard 10 may also provide an easy way of cleaning scuffs, stains, discolorations, dirt, etc. from a stair riser by providing a replaceable and/or wipeable service. As such, scuffing, as used herein, may refer to any marks, stains, discolorations, dirt, etc. on the face of the stair riser 12. Scuffguard 10 may generally include a first layer 14, a second layer 25, and a third layer 28. These parts will be described in more detail below.

The first layer 14 may be the main layer for scuffguard 10 for a stair riser 12. See FIGS. 1-5. The first layer 14 may be adapted to be attached to the stair riser 12 for providing a scuff resistant material on the face of stair riser 12. First layer 14 may have a front side 16, a back side 18, and a thickness 20. The front side 16 of first layer 14 may have a front face 22 being made from a scuff resistant material 24. This means that first layer 14 may be made from any material as long as the front face 22 is made from a scuff resistant material. In one embodiment, all of first layer 14 is made from a scuff resistant material 24. In other embodiments, just the front face 22 of first layer 14 is made from scuff resistant material 24. The first layer 14 may be any desired size or shape, including, but not limited to, any thickness 20, any width 32, or any height 33. In one embodiment, the thickness 20 of first layer 14 may be less than ½ inches. In another embodiment, the thickness 20 of first layer 14 may be less than or equal to ⅜ inches. In yet another embodiment, the thickness 20 of first layer 14 may be between 1/64 inches and ⅜ inches. In yet another embodiment, the thickness 20 of first layer 14 may be approximately or equal to ⅜ inches. In yet another embodiment, the thickness 20 of first layer 14 may be approximately or equal to 1/32 inches. In yet another embodiment, the thickness 20 of first layer 14 may be approximately or equal to 1/64 inches. The first layer 14 may be any shape, including, but not limited to, substantially rectangular shaped 30. In one embodiment, first layer 14 may be rectangular shaped 30. In one embodiment, the width 32 may be between 3-5 feet, and the height 33 may be between 4-8 inches. In another embodiment, the width 32 may be 4 feet. And in yet another embodiment, the height 33 may be 6 inches.

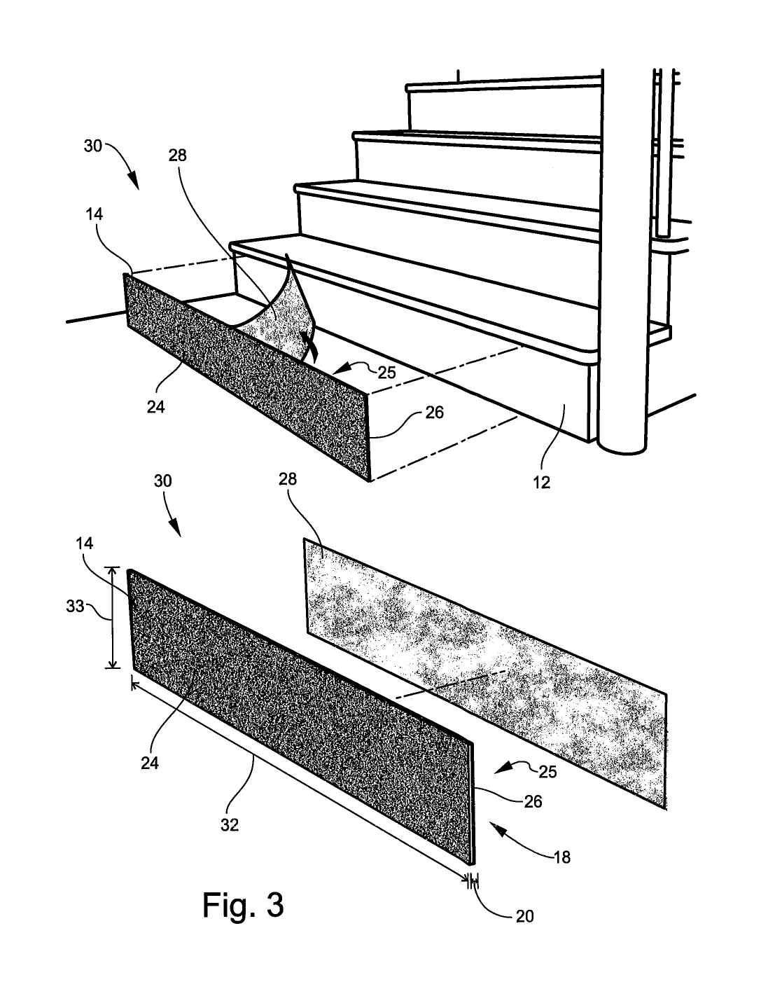

The scuff resistant material 24 may be included on the front face 22 of first layer 14 or the first layer 14 may be made completely of the scuff resistant material 24. See FIGS. 3-5. Scuff resistant material 24 may be any material that is not susceptible to scuffing, or is at least less susceptible to scuffing compared to standard risers made from painted wood or easier to clean scuffs from than standard risers made from painted wood. Scuff resistant material 24 may included, but is not limited to, polycarbonate plastic, vinyl, plexiglass, acrylic, resign, fiberglass, fabrics, wallpapers, and combinations thereof. In one embodiment, the scuff resistant material 24 may be a polycarbonate plastic.

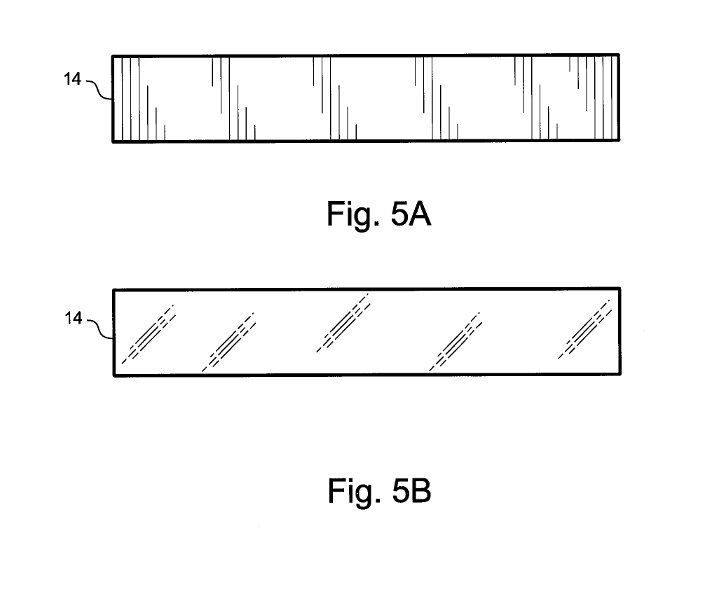

First layer 14 and/or scuff resistant material 24 may be provided in any color. See FIGS. 1-5. In one embodiment, first layer 14 and scuff resistant material 24 may be a transparent material. See FIG. 5B. This transparent embodiment of scuffguard 10 may be preferred by some users as it allows the color and patterns of the stair riser 12 to be seen through the scuffguard 10 when installed. In another embodiment, the first layer 14 and/or scuff resistant material 24 may be a color matching the stair riser 12. See FIG. 5A. This matching embodiment of scuffguard 10 may be preferred by some users as it may be less noticeable when installed as it matches the color of the stair riser 12. In yet another embodiment, the first layer 14 and/or scuff resistant material 24 may include a pattern or custom design appearance. This pattern or custom design appearance embodiment of scuffguard 10 may be preferred by some users who prefer a more custom designed stair riser 12, as the pattern or custom design appearance may match other materials used in or around the stairs 40. For example, the first layer 14 and/or scuff resistant material 24 may be made from a fabric or wall paper that matches other fabrics or wall papers used in or around the set of stairs 40.

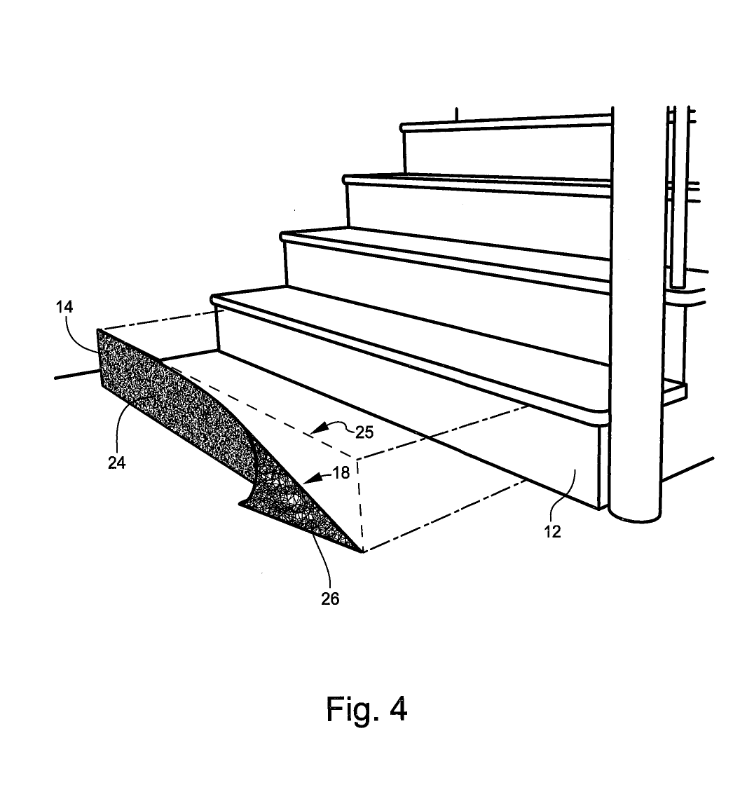

The second layer 25 may be included in scuffguard 10 and may be the attachment means for attaching first layer 14 on the stair riser 12. See FIGS. 3 and 4. Second layer 25 may include any attachment means for attaching first layer 14 on the stair riser 12, including, but not limited to, adhesive, tape, glue, hook and loop fasteners, the like, combinations thereof, etc. In one embodiment, second layer 25 may be a pressure sensitive adhesive layer 26. The pressure sensitive adhesive layer 26 may be on the back side 18 of first layer 14. The pressure sensitive adhesive layer 26 may be adapted to attach the first layer 14 to the stair riser 12. The pressure sensitive adhesive layer 26 may be positioned anywhere on the back side 18 of first layer 14. In one embodiment, the pressure sensitive adhesive layer 26 may be positioned over the entire back side 18 of first layer 14. In another embodiment, pressure sensitive adhesive layer 26 may be applied on portions of the back side 18 of first layer 14, including, but not limited to, applied in vertical lines, horizontal lines, waves, shapes, patterns, dots, combinations thereof, etc. The pressure sensitive adhesive layer 26 may be any adhesive or other like means for attaching first layer 14 to the stair riser 12. In one embodiment, the pressure sensitive adhesive layer 26 may be a repositional tape. Such suitable repositional tapes may be available from 3M of St. Paul Minn. under the product names, 3M Repositional Tape 665, 3M Repositional Tape 666, 3M Repositional Tape 9415PC, 3M Repositional Tape 9416, 3M Repositional Tape 9425, 3M Repositional Tape 9425HT, and/or 3M Repositional Tape 9449S. The pressure sensitive adhesive layer 26 may be designed for easy and quick installation of first layer 14 on stair riser 12. In addition, pressure sensitive adhesive layer 26 may also be designed for easy removal of first layer 14 from stair riser 12 without any damage to the stair riser. This feature may allow the user to easily install and change or remove the scuffguard 10 from their stairs. Thus, if scuffguard 10 becomes damaged or soiled, the user can easily remove the scuffguard 10 from his or her stairs and, if desired, easily install another scuffguard 10 to replace the damaged or soiled scuffguard 10.

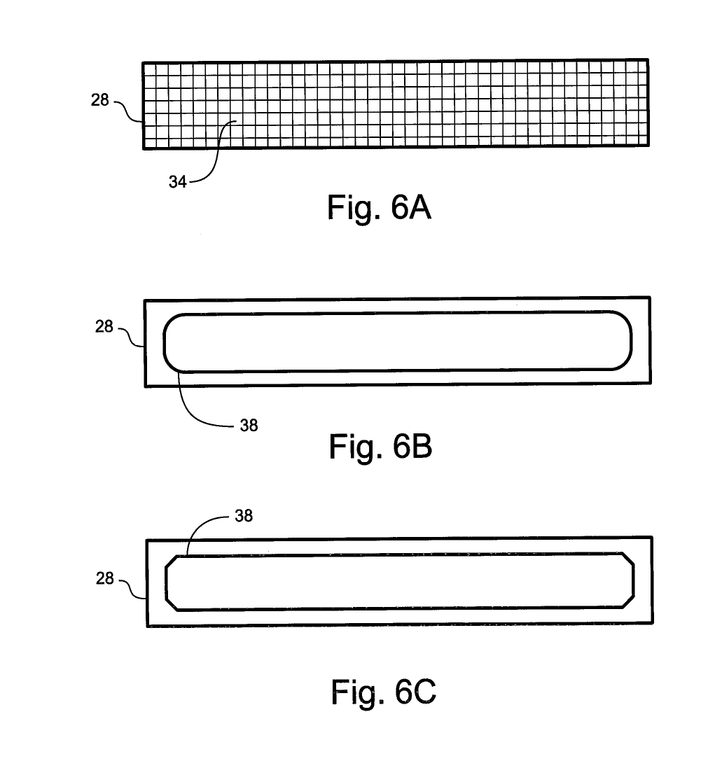

The third layer 28 may be the removable backing layer for second layer 25 or the pressure sensitive adhesive or other like material. See FIGS. 3 and 6. The third layer 28 may be any standard removable backing layer for covering the pressure sensitive adhesive prior to installation that may be removed for installation. In one embodiment, third layer 28 may be a wax paper or a paper with a wax covering. Third layer 28 may be attached to pressure sensitive adhesive layer 26, where third layer 28 may be removed from pressure sensitive adhesive layer 26 to expose pressure sensitive adhesive layer 26 for installation on the stair riser 12. In addition to being a backing layer, third layer 28 may also serve another purpose of providing cutting templates with any dimensions and/or patterns for scuffguard 10. In one embodiment, a grid 34 may be included on the back of third layer 28. The grid 34 may aid a user in cutting the first layer to a desired dimension. Grid 34 may include vertical lines, horizontal lines or combinations thereof. Grid 34 may have lines with any desired spacing to allow a user to cut so such desired spacing dimensions. In one embodiment, grid 34 may include vertical and horizontal lines 2 inches apart across the entire back side of third layer 28. In another embodiment, grid 34 may include vertical and horizontal lines 1 inches apart across the entire back side of third layer 28. Third layer 28 may also include any pattern 38 or plurality of patterns 38 for aiding a user in cutting the first layer 14 to a desired shape. The pattern 38 or plurality of patterns 38 may be any sized or shaped patterns, including, but not limited to, octagon shapes, oval shapes, circular shapes, rectangular shapes, square shapes, triangular shapes, etc. Third layer 28 may include any desired cutting templates for dimensions, like grid 34, or any desired cutting templates for patterns or shapes, like pattern 38, or any combination thereof with both cutting templates for dimensions and cutting templates for patterns or shapes.

As an alternative to the cutting templates provided on the backside of third layer 28, or in combination therewith, in one embodiment of the instant invention a custom scuffguard 10 may be provided. The custom scuffguard 10 may have a custom size and shape. This custom size and shape may be ordered by the customer and then cut to said custom size and shape prior to being shipped or delivered. In addition to the custom sizes and shapes, the custom scuffguard 10 may also be ordered with any custom design or pattern as the front face 22 of first layer 14. This may include the customer providing a picture or sample of the custom design or pattern, like a wallpaper or fabric. Accordingly, the custom scuffguard 10 may include the scuff resistant material 24 being a material adapted to match a users décor.

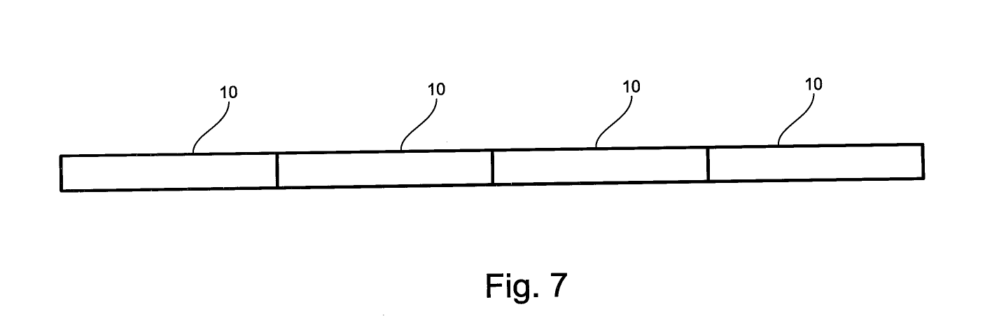

Referring to FIG. 7, in one embodiment of the instant invention, the scuffguard 10 may be adapted to attach to another scuffguard 10 or multiple scuffguards 10. This attachment feature may allow a user with wider than normal stairs (greater than 3-5 feet wide) to attach multiple scuffguards 10 together to span the width of the stairs. In this embodiment, the scuffguards 10 may be adapted to attach together by any means, including, but not limited to, utilizing pressure sensitive adhesive layer 26 or any other like attachment means.

The instant invention also includes a method of protecting a stair riser with scuffguard 10. The method of protecting a stair riser includes providing scuffguard 10 according to any one of the embodiments listed above. The step of providing scuffguard 10 may include any steps for manufacturing, marketing, distributing, selling, and delivering scuffguard 10. Once the scuffguard 10 is provided, the next step could be to remove the third layer 28 from the pressure sensitive adhesive layer 26. Third layer 28 may be removed by any means from pressure sensitive adhesive layer 26 including peeling the third layer 28 off of pressure sensitive adhesive layer 26. Finally, once the third backing layer 28 is removed, the next step could be to attach the first layer 14 to the stair riser via the pressure sensitive adhesive layer 26. This step is the final step of installing the scuffguard 10 on the stair riser. The step of attaching first layer 14 to the stair riser may include any means for attachment, including any means for lining up and/or leveling first layer 14 on stair riser 12, and any means for applying pressure to the scuffguard 10 to attach it to the stair riser.

In the embodiment where the third layer 28 includes a cutting template and a user desires to cut the first layer to a desired dimension and/or pattern or plurality of patterns, the method described above of protecting a stair riser with scuffguard 10 may include additional steps. The cutting template may be grid 34 for aiding a user in cutting said first layer to a desired dimension, or the cutting template may be pattern 38 or plurality of patterns 38 for aiding a user in cutting first layer 14 to a desired shape or plurality of shapes, or the cutting template may be a combination thereof. As such, the additional steps of the instant method of protecting a stair riser may include the step of cutting the first layer via grid 34 and/or one of patterns 38 to a desired dimension or shape prior to removing the third layer 28 from said pressure sensitive adhesive layer 26.

The present invention may be embodied in other forms without departing from the spirit and the essential attributes thereof, and, accordingly, reference should be made to the appended claims, rather than to the foregoing specification, as indicated in the scope of the invention.

1. A scuffguard for a stair riser comprising:
a first layer having a front side, a back side, and a thickness between 1/64 inches and ⅜ inches;
said front side having a front face being made from a scuff resistant material being selected from the group consisting of: scuff resistant polycarbonate plastic, vinyl, plexiglass, acrylic, resign, fiberglass, fabrics, wallpapers, and combinations thereof;
a second layer being a pressure sensitive adhesive layer on the back side of said first layer for attaching said first layer to a stair riser, whereby, said scuffguard may be installed on the stair riser via said pressure sensitive adhesive layer; and
a third layer being removably attached to said pressure sensitive adhesive layer, where said third layer may be removed from said pressure sensitive adhesive layer to expose said pressure sensitive adhesive layer for installation on the stair riser;
wherein said third layer including:
a grid for aiding a user in cutting said first layer to a desired dimension; or
a pattern or plurality of patterns for aiding a user in cutting said first layer to a desired shape.

2. (canceled)

3. The scuffguard for a stair riser of claim 1 wherein said first layer being made from a transparent material.

4. The scuffguard for a stair riser of claim 1 wherein said front side having a color matching the stair riser.

5. The scuffguard for a stair riser of claim 1 wherein said front side including a fabric or wall paper material having a pattern.

6. (canceled)

7. (canceled)

8. The scuffguard for a stair riser of claim 1 wherein said first layer being substantially rectangular shaped with a length and a width;
said width being between 3-5 feet; and
said height being between 4-8 inches.

9. The scuffguard for a stair riser of claim 8 wherein:
said width being 4 feet; and
said height being 6 inches.

10. The scuffguard for a stair riser of claim 1 wherein:
said pressure sensitive adhesive layer being on the entire back side of said first layer; or
said pressure sensitive adhesive layer being applied on portions of the back side of said first layer being selected from the group consisting of: vertical lines, horizontal lines, waves, shapes, patterns, dots, and combinations thereof.

11. The scuffguard for a stair riser of claim 1 wherein said pressure sensitive adhesive layer being a repositional tape.

12. (canceled)

13. (canceled)

14. A set of stairs with a plurality of stairs each having a stair riser comprising:
at least one scuffguard according to claim 1 attached to a said stair riser.

15. A custom scuffguard for a stair riser comprising:
a first layer having a front side, a back side, a thickness between 1/64 inches and ⅜ inches and having a custom size and shape;
said front side having a front face being made from a scuff resistant material being selected from the group consisting of: scuff resistant polycarbonate plastic, vinyl, plexiglass, acrylic, resign, fiberglass, fabrics, wallpapers, and combinations thereof; and
said scuff resistant material being a material adapted to match a users dècor;
a second layer being a pressure sensitive adhesive layer on the back side of said first layer for attaching said first layer to a stair riser, whereby, said custom scuffguard may be installed on the stair riser via said pressure sensitive adhesive layer; and
a third layer being removably attached to said pressure sensitive adhesive layer, where said third layer may be removed from said pressure sensitive adhesive layer to expose said pressure sensitive adhesive layer for installation on the stair riser;
wherein said third layer including:
a grid for aiding a user in cutting said first layer to a desired dimension; or.
a pattern or plurality of patterns for aiding a user in cutting said first layer to a desired shape.

16. The custom scuffguard for a stair riser of claim 15 wherein:
said pressure sensitive adhesive layer being on the entire back side of said first layer; or
said pressure sensitive adhesive layer being applied on portions of the back side of said first layer being selected from the group consisting of: vertical lines, horizontal lines, waves, shapes, patterns, dots, and combinations thereof.

17. (canceled)

18. The custom scuffguard for a stair riser of claim 15 wherein said scuff resistant material being a fabric or wallpaper.

19. A method of protecting a stair riser with a scuffguard comprising the steps of:
providing a scuffguard for a stair riser comprising:
a first layer having a front side, a back side, and a thickness between 1/64 inches and ⅜ inches;
said front side having a front face being made from a scuff resistant material being selected from the group consisting of: scuff resistant polycarbonate plastic, vinyl, plexiglass, acrylic, resign, fiberglass, fabrics, wallpapers, and combinations thereof;
a second layer being a pressure sensitive adhesive layer on the back side of said first layer for attaching said first layer to a stair riser; and
a third layer being removably attached to said pressure sensitive adhesive layer, where said third layer may be removed from said pressure sensitive adhesive layer to expose said pressure sensitive adhesive layer for installation on the stair riser, wherein said third layer including:
a grid for aiding a user in cutting said first layer to a desired dimension; or
a pattern or plurality of patterns for aiding a user in cutting said first layer to a desired shape;
removing said third layer from said pressure sensitive adhesive layer; and
attaching said first layer to said stair riser via said pressure sensitive adhesive layer.

20. The method of protecting a stair riser with a scuffguard of claim 19
further comprising the step of:
cutting said first layer via said grid or one of said patterns to a desired dimension or shape prior to removing said third layer from said pressure sensitive adhesive layer.
